(19) United States
(12) Patent Application Publication
(10) Pub. No.: US 2024/0354516 A1
(43) Pub. Date: Oct. 24, 2024

(54) TECHNIQUES FOR STREAMLINING LANGUAGE DATA PROCESSING USING A CENTRALIZED PLATFORM OF MULTI-STAGE MACHINE LEARNING ALGORITHMS

(71) Applicant: GONG.io Ltd., Ramat Gan (IL)

(72) Inventors: Guy Netser EYAL, Jerusalem (IL); Shlomi MEDALION, Lod (IL); Victoria AIZENBERG, Netanya (IL); Ortal ASHKENAZI, Kfar-Saba (IL); Eyal BEN-DAVID, Kibbutz Yagur (IL); Guy ROTMAN, Haifa (IL); Sagy HARPAZ, Ramat Gan (IL); Alon BERLINER, Zichron Yaakov (IL); Inbal HOREV, Tel Aviv (IL); Dolev POMERANZ, Hod-Hasharon (IL)

(73) Assignee: GONG.io Ltd., Ramat Gan (IL)

(21) Appl. No.: 18/629,369

(22) Filed: Apr. 8, 2024

Related U.S. Application Data
(60) Provisional application No. 63/497,091, filed on Apr. 19, 2023.

(51) Int. Cl. G06F 40/40; G06F 40/166; G06F 40/279

(52) U.S. Cl. CPC G06F 40/40; G06F 40/166; G06F 40/279

(57) ABSTRACT

A system and method for streamlining language data processing through a multi-stage pipeline is presented. The method includes creating, based on input data, a targeted message for a lead using a trained generator, wherein the input data includes lead data; causing projection of the targeted message via a user device of the lead; determining at least a label for interaction data by applying a classifier, wherein the interaction data is collected from causing the projection of the targeted message to the lead, wherein the interaction data are processed for classification; determining a next step based on the determined at least a label, wherein the next step is determined with respect to the lead; and performing the next step upon determination.

### CROSS-REFERENCE TO RELATED APPLICATIONS

This application claims the benefit of U.S. Provisional Application No. 63/497,091 filed on Apr. 19, 2023, the contents of which are hereby incorporated by reference.

### TECHNICAL FIELD

The present disclosure relates generally to processing textual data, more specifically to streamlining textual data processing and transfer via a centralized platform.

### BACKGROUND

Customer service representatives, account executives, sales development representatives, customer success managers, and other business-to-customer (B2C) and business-to-business (B2B) representatives rely on following up and communicating with customers or potential customers in order to achieve their goals. Manually setting reminders and follow-ups can be incredibly cumbersome, particularly when each employee is engaged in a high volume of calls requiring such follow ups. Some solutions for automating reminders exist. However, these solutions face challenges in processing the exponential amount of message data being generated on a daily basis. Moreover, many such solutions often apply naïve rules for setting reminders, which either provide too few reminders (thereby missing potentially fruitful conversations) or too many reminders (thereby defeating the purpose of such an automated system and overwhelming employees with low value reminders). Solutions can utilize more complex rulesets and/or machine learning in order to improve accuracy, but these measures require more computing resources.

Solutions for improving the efficiency and accuracy of automated engagements and communications are therefore highly desired. In particular, solutions that allow for reducing the amount of computing resources needed to be devoted to processing high volumes of data are desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for streamlining language data processing through a multi-stage pipeline. The method comprises: creating, based on input data, a targeted message for a lead using a trained generator, wherein the input data includes lead data; causing projection of the targeted message via a user device of the lead; determining at least a label for interaction data by applying a classifier, wherein the interaction data is collected from causing the projection of the targeted message to the lead, wherein the interaction data are processed for classification; determining a next step based on the determined at least a label, wherein the next step is determined with respect to the lead; and performing the next step upon determination.

Certain embodiments disclosed herein also include a non-transitory computer readable medium having stored thereon causing a processing circuitry to execute a process, the process comprising: creating, based on input data, a targeted message for a lead using a trained generator, wherein the input data includes lead data; causing projection of the targeted message via a user device of the lead; determining at least a label for interaction data by applying a classifier, wherein the interaction data is collected from causing the projection of the targeted message to the lead, wherein the interaction data are processed for classification; determining a next step based on the determined at least a label, wherein the next step is determined with respect to the lead; and performing the next step upon determination.

Certain embodiments disclosed herein also include a system for streamlining language data processing through a multi-stage pipeline. The system comprises: a processing circuitry; and a memory, the memory containing instructions that, when executed by the processing circuitry, configure the system to: create, based on input data, a targeted message for a lead using a trained generator, wherein the input data includes lead data; cause projection of the targeted message via a user device of the lead; determine at least a label for interaction data by applying a classifier, wherein the interaction data is collected from causing the projection of the targeted message to the lead, wherein the interaction data are processed for classification; determine a next step based on the determined at least a label, wherein the next step is determined with respect to the lead; and perform the next step upon determination.

Certain embodiments disclosed herein include the method, non-transitory computer readable medium, or system noted above or below, further including or being configured to perform the following step or steps: receiving a list of a plurality of potential leads, wherein the list of the plurality of potential leads includes a subset of potential leads that are ranked based on scores, wherein each potential lead in the list of the plurality of potential leads have a score above a predetermined threshold value; and selecting lead from the list of the plurality of potential leads.

Certain embodiments disclosed herein include the method, non-transitory computer readable medium, or system noted above or below, further including or being configured to perform the following step or steps: iteratively repeating creating, causing projection, and processing the collected interaction data in near real-time.

Certain embodiments disclosed herein include the method, non-transitory computer readable medium, or system noted above or below, wherein the trained generator is a customized language model that is trained for at least one of: a company, an entity, an industry, and a topic.

Certain embodiments disclosed herein include the method, non-transitory computer readable medium, or system noted above or below, wherein the topic is a context of a subject matter in the language data, wherein the language data includes at least one topic.

Certain embodiments disclosed herein include the method, non-transitory computer readable medium, or system noted above or below, further including or being configured to perform the following step or steps: extracting relevant data using a trained language model from the input data, wherein the input data is expressed as vector embeddings; formatting the extracted relevant data to create a unified data format, wherein formatting includes splitting data to fixed-size data chunks; creating a prompt for the trained generator, wherein the prompt includes a command, background details, and textual data of the formatted relevant data; and feeding the prompt into the trained generator.

Certain embodiments disclosed herein include the method, non-transitory computer readable medium, or system noted above or below, wherein the targeted message is caused to be projected as at least one of: a text, an audio, a video, an image, a multimedia, and a virtual form.

Certain embodiments disclosed herein include the method, non-transitory computer readable medium, or system noted above or below, further including or being configured to perform the following step or steps: collecting feedback data from at least one stage of the multi-stage pipeline; and applying the feedback data to the trained generator to update the trained generator.

Certain embodiments disclosed herein include the method, non-transitory computer readable medium, or system noted above or below, wherein the classifier is a multi-label classifier that applies at least one of: a neural network, a gradient-based algorithm, and a supervised machine learning algorithm.

Certain embodiments disclosed herein include the method, non-transitory computer readable medium, or system noted above or below, further including or being configured to perform the following step or steps: retrieving a lead calendar and a user calendar; identifying a potential meeting time slot by applying an algorithm to the retrieved lead calendar, retrieved user calendar, and the lead data; and causing a display of a reminder, wherein the reminder is generated based on the identified potential meeting time slot.

Certain embodiments disclosed herein include the method, non-transitory computer readable medium, or system noted above or below, wherein the display is presented as a part of a sales pipeline that indicates an engagement progress.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for streamlining engagement through a multi-stage pipeline according to an embodiment.

FIG. 3 is a flowchart illustrating a method for aggregating potential leads according to an embodiment.

FIG. 4 is a flowchart illustrating a method for creating targeted messages using a generator according to one embodiment.

FIG. 5 is a flowchart illustrating a method for performing a follow-up step according to an example embodiment.

FIG. 6 is a flowchart illustrating a method for scheduling a meeting according to an example embodiment.

FIG. 7 is a flow diagram of an engagement pipeline according to example embodiments.

FIG. 8 is a schematic diagram of a pipeline manager according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments provide a technique for streamlining language data processing using a multi-stage pipeline of machine learning algorithms. The method described herein provides efficient analyses of input and intermediate data that are collected during different stages of the multi-stage pipeline. In an embodiment, one or more components are deployed in a centralized platform in order to process language data in a streamline manner. The centralized platform reduces transmission delays to allow rapid processing of language data. Moreover, the input data and intermediate data that are collected at different stages of the multi-stage pipeline may be easily shared and transferred to minimize redundant analyses of certain data.

The embodiments disclosed herein implement one or more machine learning models in the multi-stage pipeline to accurately and efficiently process language data and to effectively determine the most relevant next steps for at least one engagement with a customer (e.g., the lead). A customized language model is utilized to create a targeted message for the lead based on input data such as, but not limited to, the lead data (e.g., professional, personal, etc.), interaction data (e.g., historical, current, etc.), metadata (e.g., participating person, time frame, etc.), and the like, and any combination thereof. Moreover, the targeted message may be projected to the lead to collect interaction data with respect to the projection via, for example, an input/output (I/O) device of a lead device. The interaction data may be analyzed for the understanding of context and content and classified by a multi-label classifier. In an embodiment, the interaction data is language data that may be collected in various forms such as, but not limited to, a text, an image, a video, an audio, a multimedia, a virtual form, and the like, and any combination thereof. In a further embodiment, the next step for the respective lead may be determined with respect to the interaction data that is classified and labeled.

It has been identified that language data are often large in size and followed by notable amounts of processing time and power for analyses. In addition, exponential amounts of language data are generated and collected to be analyzed in businesses, particularly in customer engagement processes. However, the disclosed embodiments readily transmit and share input data as well as intermediate data that are collected and/or generated during the multi-stage pipeline, thereby reducing computing time, power, and memory in the language data processing.

As an example, the targeted message is generated for projection to the lead. Upon projection of the targeted message, an interaction data (or response) of the lead to the targeted message is collected. In such a scenario, the lead data, targeted message, and interaction data are available to a generator and/or a classifier for rapid analyses and eliminating redundant analyses of the targeted message and/or lead data. On a counterpart example, when a projected message is unknown, a classifier may need to collect each of the lead data, the projected message, and the interaction data and further, process each of the data for further classification. To this end, the disclosed embodiments eliminate repeated processing of large language data, thereby conserving computing resources.

Moreover, the embodiments described herein provide consistent and objective determination of the next step using the multi-stage pipeline. At each stage of the multi-stage pipeline such as, creating the targeted message and determining at least a label by classification, a trained machine learning model, which includes weights, scores, rules, and the like, is utilized to provide accurate and consistent determination. While a person may manually create messages and label an interaction data, such a manual process requires extensive time, is inconsistent, and ultimately, a subjective process.

That is, the person manually performing such stages may be making choices based on their feelings or limited (or none) knowledge of the lead, the topic, the industry, the company, and more. The disclosed embodiments herein provide for objective determination of the next step based on an objective creation of targeted messages and objective classification into one or more labels. It should be noted that such targeted messages and classification may be customized to, for example, but not limited to, company, entity, industry, topic, and the like, and any combination thereof, thereby providing consistently accurate and effective language processing through the multi-stage pipeline.

It should be further noted that the vast amount of data, not only of language data, but other relevant data such as, but not limited to, potential leads, lead data including professional and personal data for the potential leads, industry data, company data, topic data, sentiment data, and the like, and any combination thereof, are continuously collected. To this end, collecting, processing, and analyses of vast amounts of data may not feasibility be performed manually. Moreover, in some embodiments, the multi-stage pipeline may be performed in near real-time or real-time during an engagement session with a lead. An example may be during a telephone conversation, chat, and the like. In such a scenario, the multi-stage pipeline including the one or more machine learning models is performed at sufficiently rapid rates to allow the real-time interaction. It should be appreciated that the disclosed embodiments that provide efficient language data processing may be employed for effective and accurate determination and interaction.

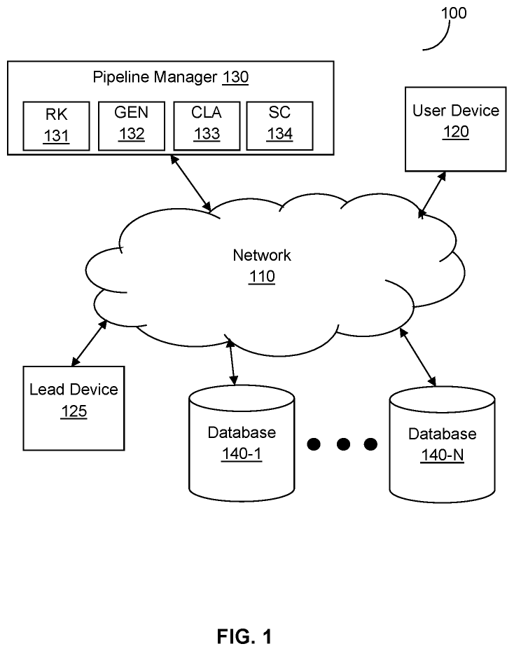

FIG. 1 shows an example network diagram 100 utilized to describe the various disclosed embodiments. In the example network diagram 100, a user device 120, a lead device 125, a pipeline manager 130, and a plurality of databases 140-1 through 140-N (hereinafter referred to individually as a database 140 and collectively as databases 140, merely for simplicity purposes) are communicatively connected via a network 110. The network 110 may be, but is not limited to, a wireless, a cellular, or wired network, a local area network (LAN), a wide area network (WAN), a metro area network (MAN), the Internet, the worldwide web (WWW), similar networks, and any combination thereof.

The user device 120 may be, but is not limited to, a personal computer, a laptop, a tablet computer, a smartphone, a wearable computing device, or any other device capable of receiving and displaying the processed output at various stages of the multi-stage pipeline. In an embodiment, the user device 120 is configured to display message data such as, but not limited to, text messages, text-to-speech outputs, audio data, and the like, generated by the pipeline manager 130. In a non-limiting example embodiment, the user device 120 may be associated with a sales representative that interacts and engages with a lead (or customer) through a sales process (or an engagement pipeline). The sales process is a series of steps from a product and market research all the way through a closed deal with the lead. The closing of a deal may occur at any step of the sales process. In an embodiment, the user device 120 is configured to display a sales pipeline that is a visual representation of a position and progress of a specific lead in the sales process. The sales pipeline indicates where in the sales process (e.g., which step) the lead is currently at.

In a further embodiment, the user device 120 is configured to display engagement progress within the stages of the engagement pipeline (for example, as the sales pipeline) including labels for each interaction with a lead. In an example embodiment, a user (e.g., a sales associate, employee of a company, etc.) is presented with a report for a customer (or lead) that an initial interaction has occurred. In the same example, the report includes basic customer information, an email sent to the customer for the initial interaction, and a label of “meeting booked.” In a further embodiment, the user may interact with the report and/or notification via a graphical user interface (GUI) using the user device 120. The user of the user device 120 is provided with the sales pipeline for the visual representation of the sales process.

The lead device 125 may be, but is not limited to, a personal computer, a laptop, a tablet computer, a smartphone, a wearable computing device, or any other device capable of receiving and displaying message data created by the pipeline manager 130 for engagement. The message data may be at least one of textual data, audio data, video data, multimedia data, and the like that is personalized and specific to the lead. The lead device 125 is associated with the potential lead (or customer) for which the engagement is initiated with, and communication is sent to. That is, the potential lead is an external entity for interaction and/or communication through the engagement pipeline employing the multi-stage pipeline. In an embodiment, the lead device 125 may be utilized to input lead response based on the projected message data. The lead device 125 may be further equipped with one or more I/O devices, for example, but not limited to, a microphone, a speaker, and the like. The microphone may be used to capture spoken words by the lead as audio data and the speaker may be used to output audio data generated by the pipeline manager 130. As an example, the lead device 125 displays an email generated and caused to be displayed by the pipeline manager 130. The lead device 125 receives customer (or lead) input as an email response as text, which is communicated to the pipeline manager 130 for the next stages in the multi-stage pipeline of the engagement pipeline. The engagement pipeline includes a series of steps that may occur during engagement with the lead, for example, between initial contact to completing the engagement through an agreement. Some example steps in between are, without limitation, scheduling a meeting, telephonic conversation, sending a request, completing a request, receiving payment, and the like, and more.

The pipeline manager 130 is configured to streamline engagement and assessment using a network of machine learning models as described herein. According to the various disclosed embodiments, the pipeline manager 130 includes a ranker (RK) 131, a generator (GEN) 132, a classifier (CLA) 133, and a scheduler (SC) 134. Each of the ranker 131, the generator 132, the classifier 133, and the scheduler 134 may be a software component, a hardware component, or both. In an embodiment, each component 131 through 134 is or includes a model configured for a particular function. At least some of these models are machine learning models and, in particular, machine learning models and/or large language models trained as discussed herein. The trained models as disclosed herein provide accurate results efficiently, thereby allowing the overall language data processing in the engagement to be faster and less repetitious.

The pipeline manager 130 is configured to perform the multi-stage pipeline in the engagement processes to efficiently and accurately process language data. In some implementations, the multi-stage pipeline allows improved engagement with the leads to achieve a successful closing on, for example, a deal, sales, professional connection, and the like. It should be noted that communications between the multiple components and stages of the multi-stage pipeline are rapidly performed to reduce processing speed. Moreover, ranking and selections performed through the pipeline progressively and selectively reduce the amount of data to be processed to conserve computing power and time. The pipeline manager 130 is configured as a centralized platform including a network of machine learning models that streamline the engagement process and assess engagements. In an embodiment, the multi-stage pipeline may be implemented at different steps of the engagement process, herein also referred to as the engagement pipeline. In an example embodiment, the engagement process is a sales process from initial product and market research all the way to closing a deal. The sales process includes a series of steps for the sales representative (e.g., a user of the user device) to perform. In an example embodiment, the multi-stage pipeline may be employed in one or more steps of the sales process. The sales process includes multiple steps (or stages) of engaging with a customer from initiation to completing the engagement such as, but not limited to, signing a contract, reaching an agreement, reaching the user target for payment, making a connection, and the like, and any combination thereof.

The ranker (RK) 131 is configured to identify and generate a list of potential leads based on input data. The input data may include lead data such as, but not limited to personal information (e.g., demographics, geographical location, hobbies, age group, more), professional information (e.g., current job, job title, industry, experiences, and more), historical data on previous interactions, metadata and the like, and any combination thereof. In an embodiment, such lead data are collected from various internal and external sources, for example, but not limited to, social media, forums, company websites, online, directories, CRM system, and the like, and more. As an example, the list of potential leads includes leads (or customers) that are collected from an online directory. In some embodiments, the lead data may be collected for a group that is identified as a potential customer including, for example, group information (e.g., geographical location, majority demographics, industry, etc.). An example of such a group may be a particular unit in a company, a department of an institution, and more. The ranker 131 is further configured to generate at least one ranking sorted based on a score determined for each of the potential leads. In an example embodiment, the score indicates a probability that an engagement pipeline will be completed to result, for example, a successful closing of a deal. In another example, the score indicates a probability of fit to the user's company and/or product. In an embodiment, the potential leads and the respective scores may be stored in a database 140. In an embodiment, potential leads with scores equal to or greater than a high threshold value may be selected to be further processed in the generator 132. In an example embodiment, potential leads with scores below a low threshold value indicate very low probabilities of completing the engagement pipeline and thus, may not be further processed. The selected potential leads are included in a subset of potential leads.

The generator (GEN) 132 is configured to generate a targeted message that is tailored to the potential lead. The targeted message is personalized for a specific potential lead that is selected from the rankings determined by the ranker 131. The targeted message includes message data generated by the generator 132 and may be used interchangeably herein within. The message data is, for example, but not limited to, textual data, audio data, video data, multimedia data, and the like, and any combination thereof, and the message data generated herein is personalized for a specific potential lead. The generator 132 is configured to utilize at least one of a language model, a large language model, an advanced language model, and the like to create message data based on input data and output as natural language. In a further embodiment, the generator 132 utilizes algorithms such as a text-to-speech (TTS) model to output message data as audio data.

The input data include, for example, but are not limited to, personal data, professional data, interaction data, and the like that are collected from, for example, databases 140, social media, company websites, online directories, CRM systems, and the like, and any combination thereof. The interaction data includes historical data and current interaction data with a lead such as, but not limited to, projected targeted message, lead's response, metadata associated with the interaction, sentiments, topics, and the like, and more. In an embodiment, the targeted message is output in a text format as, for example, but not limited to, an email message, chat message, short message system (SMS) message, and the like. In another embodiment, the targeted message is output in an audio format, for example, a telephonic call, voice message, and the like. In yet another embodiment, the targeted message is output in a multimedia format, for example, a video clip, and the like. It should be noted that different targeted messages may be determined for the same lead based on, for example, previous interaction data.

The models in generator 132 may implement machine learning models that are trained to improve accuracy in understanding contents, generate relevant message data, optimize output, and the like. In an embodiment, ML models learn from feedback data, such as, but not limited to, success rates, labels, and the like, received at different stages of the multi-stage pipeline and/or the engagement pipeline to enhance accuracy and efficiency.

It should be noted that the generator 132 utilizes at least one of the natural language, TTS, and automatic speech recognition (ASR) models enabling automated interaction with potential leads to further streamline the multi-stage pipeline and/or engagement pipeline, which in return eliminates redundant data processing, unnecessary data transmissions, and the like, to improve computer efficiency. It should be further noted that the automated engagement enables objective generation and output of targeted messages based on input data. As an example, messages generated can be subjective and inconsistent depending on the personality and/or mood of a person generating the message at the time. However, such subjectivity may be removed by the implementation of trained models to output objective and consistent messages that are accurately tailored to the specific potential lead.

In some implementations, according to the disclosed embodiments, the generator 132 is configured to generate targeted messages during real-time engagement sessions with a lead. In an example embodiment, the generator 132 is utilized in a real-time chat communication with a lead. The generator 132 creates targeted message data based on input data such as, but not limited to, the lead data, interaction data, and the like. Higher weights may be given to, for example, interaction data collected during the current interaction session, immediate response from the lead, and the like, to generate targeted message data that are aligned with the immediate response from the lead and the current interaction. It should be noted that the targeted message data are generated and output in coherence to the immediate response from the lead for continued back and forth conversation-like communications with the lead during the interaction session. Similarly, in another example embodiment, the generator 132 implementing ASR and TTS models may be further utilized in real-time on-call communications with a lead using audio data. It should be noted that the real-time engagement session involves, for example, and without limitation, real-time transcription, understanding of context, generating of message data, and more. It should be further noted that real-time engagement sessions may be performed using various formats such as, but not limited to, text, audio, video, image, and the like, and more. The language data processing is performed by applying at least one language model or large language model (LLM) such as, but not limited to, such as Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

The classifier (CLA) 133 is configured to determine a label of an interaction with the potential lead. A response, which includes no response, to the projected targeted message is received as interaction data that are processed and classified. The classifier may determine a label such as, but not limited to, “follow-up”, “wrong person”, “voicemail”, “bad timing”, “meeting booked”, and the like for each interaction data. In an embodiment, the classifier 133 is a multi-label classifier that applies at least one algorithm such as, but not limited to, neural network, gradient-based algorithm, supervised machine learning algorithms, and the like on the interaction data. In a further embodiment, the classifier 133 may also receive lead sentiments, engagement metrics, domain specific knowledge, information from other sources, and the like, and more, for classification. In an embodiment, the classifier 133 is trained using a training dataset. In an embodiment, the labels are used to determine the next step of the engagement pipeline. In an embodiment, the next step may be predetermined for each of the labels. It should be noted that classifier 133 enables efficient labeling of interactions that guide the next step of the engagement pipeline as well as for insights on the engagement. In some embodiments, groups of interaction data from engagement sessions (e.g., lead responses during a single engagement session, lead responses from multiple closely performed engagement sessions, etc.) may be utilized for classifying the interaction with the lead. In an embodiment, the interaction data and the respective label are stored at a database 140.

The scheduler (SC) 134 is configured to identify potential meeting time slots for applicable prospective leads based on lead data. In an embodiment, the SC 134 may utilize lead and user (e.g., the sales manager) calendars, lead data, and preferences (if received as input), as well as historical data of the current deal, lead, and/or user, to generate optimal time slots. The SC 134 is further configured to generate reminders for the identified time slots and determine, for example, time, frequency, and type of communication, for sending and projecting the reminders to the user and/or the lead.

It should be noted that the components 131 through 134 as well as the various models are described as being part of a single pipeline manager 130 with respect to FIG. 1 for simplicity purposes, but that any or all of these components and models may be implemented as or in separate systems without departing from the scope of the disclosure.

The databases 140 include potential leads (or contact pool), lead data, historical data (e.g., previous interaction data, a success rate of previous engagements, etc.), and the like that are utilized in the pipeline manager 130. Various intermediate result data from transcripts, recorded calls or conversations, email messages, chat messages, instant messages, short message systems (SMS), chat logs, comments left on calls, information from a product board, customer relationship management (CRM) data, to other types of relevant documents (e.g., textual documents, audio recordings, video call recordings, and more) may be stored in the databases 140. Such intermediate result data may be collected in association with the lead, company, user (e.g., sales associate), and the like.

In an embodiment, the intermediate result data stored in the databases 140 may be data that are utilized, generated, determined, and collected during the processes through the multi-stage pipeline and, in return, the engagement pipeline via the pipeline manager 130. In an example embodiment, the intermediate result data may include created targeted messages, responses from the lead during interaction, conversations shared in the interaction, and the like, and more. In an embodiment, the database 140 may include metadata on the interaction data such as, but not limited to, time stamps, participant information, and the like, and any combination thereof. In another example embodiment, the database 140 may include labels for each interaction data, rankings for potential leads, and the like. The database 140 may further store predetermined user preferences such as, and without limitation, company-specific terminology, user-specific format, and the like, and any combination thereof.

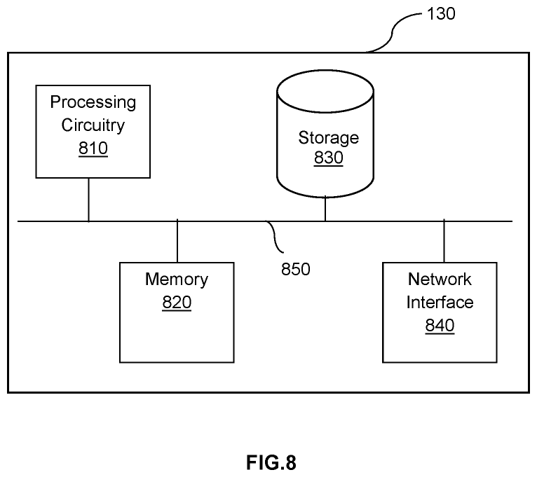

The pipeline manager 130 may be realized as a physical machine (an example of which is provided in FIG. 8), a virtual machine (or other software entity) executed over a physical machine, a cloud computing resource, and the like. In an embodiment, the pipeline manager 130 is configured to run at least one of the models of the ranker 131, generator 132, the classifier 133, and the scheduler 134, as described above.

It should be noted that the elements and their arrangement shown in FIG. 1 are shown merely for the sake of illustration and simplicity. Other arrangements and/or a number of elements should be considered without departing from the scope of the disclosed embodiments. For example, the user device 120, pipeline manager 130, and the databases 140, may be part of one or more data centers, server frames, or a cloud computing platform. The cloud computing platform may be a private cloud, a public cloud, a hybrid cloud, or any combination thereof.

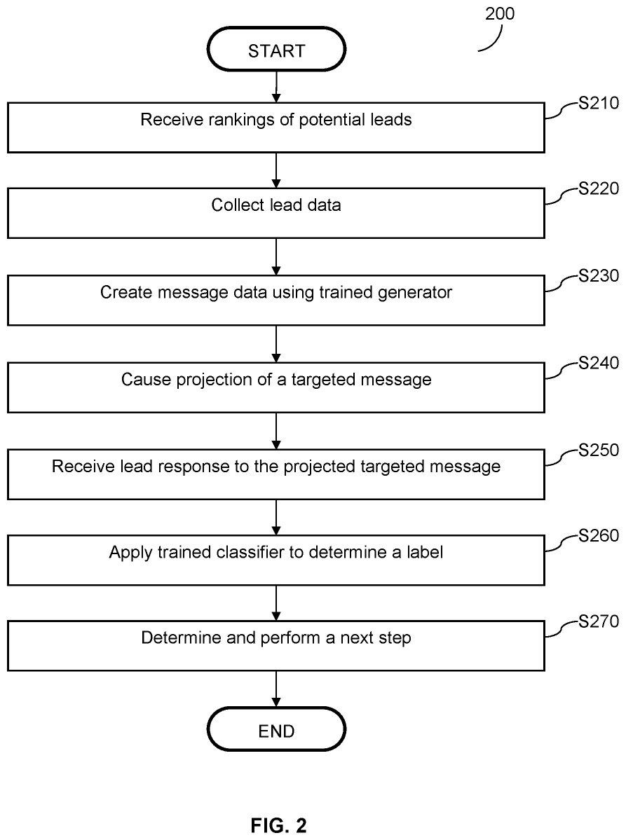

FIG. 2 is an example flowchart 200 illustrating a method for streamlining engagement according to an embodiment. The method described herein may be executed by a pipeline manager 130, FIG. 1.

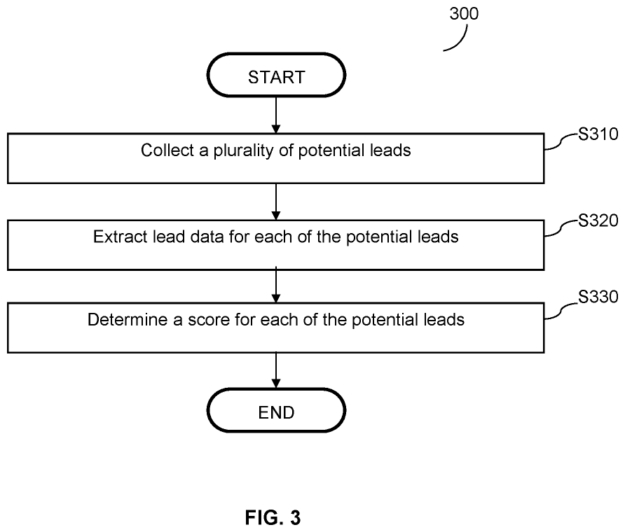

At S210, rankings of potential leads are received. The ranking lists the potential leads ranked in the order of highest probability of successful engagement and/or sales to lowest probability and is determined as described in FIG. 3 below. In some embodiments, portions of the rankings, including potential leads with scores greater than a threshold value, may be received to reduce data transmission and processing. The identified potential leads may be added to a subset of potential leads.

In an embodiment, steps S220 through S270 may be performed for at least one potential lead that is selected from the received ranking. It should be noted that the steps below are performed for each of the at least one potential lead. In a further embodiment, such steps may be performed independently for each of the at least one potential lead and concurrently for rapid processing.

At S220, lead data is collected. The lead is one of the potential leads that were received in the ranking. In an example embodiment, the lead that is relatively higher in rank is selected which indicates that the lead has a higher chance to be a customer and/or agree to close a deal. In an embodiment, the data for the lead includes, for example, personal information, professional information, and the like, and any combination thereof. Such data may be collected from the database (e.g., the database 140, FIG. 1) as well as external sources, for example, but not limited to, a CRM system, social media, company websites, and the like.

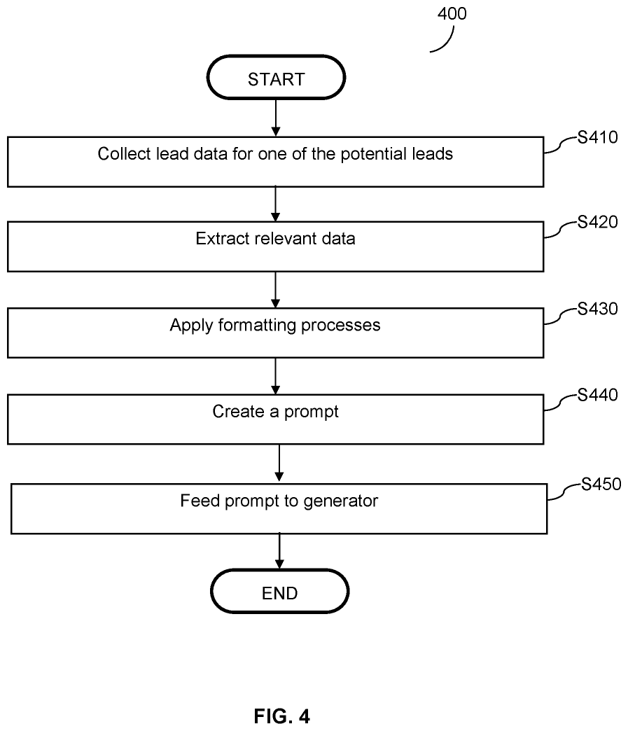

At S230, message data are created using a trained generator. The trained generator (e.g., the generator 132, FIG. 1) is configured to create message data (or targeted messages) that are personalized to the specific lead. In an embodiment, input data such as, but not limited to, personal information, professional information, historical data on previous interactions, and the like, are utilized to generate the message data. In an embodiment, the generator may be trained using company-specific data to generate a customized generator. In an embodiment, the generator uses at least one of a deep neural network (DNN) model, a recurrent neural net (RNN) model, a transformer model, as well as language models or large language models, such as GPT3, GPT-J, T5, BART architectures, and others, and the like to create the targeted messages that are specific for the respective lead. The method to create message data of targeted messages is described in detail in FIG. 4 below. In an embodiment, the message data may be, for example, but not limited to, textual data, audio data (e.g., text-to-audio output), video data, multimedia data, and the like.

At S240, the targeted message is caused to be projected. The targeted message that includes the created message data may be provided to the lead device (e.g., the lead device 125, FIG. 1). In an embodiment, the targeted message may be displayed in a text format, for example, email message, short message system (SMS), and the like. In another embodiment, the created textual data may be converted to audio data to be projected using resources, for example, a speaker, on the lead device by applying a TTS model. It should be noted that the targeted messages may be projected in various formats according to message data type, interaction with the lead, preference of user and/or lead, and the like, and any combination thereof. In an embodiment, the textual data may also be displayed on a user device (e.g., the user device 120, FIG. 1) for the user (e.g., sales team) to observe.

At S250, a lead response to the projected targeted message is received. The lead response is received in any one of textual data, audio data, video data, and the like via a lead device (e.g., the lead device 125, FIG. 1) over the network. In an embodiment, the ASR model is applied to the audio data to generate corresponding textual data. In an embodiment, the ASR model may be a customized model trained to identify words that are specific to, for example, a company, a topic, an industry, and the like. In a further embodiment, an interaction data including the lead's response may be further analyzed using at least one algorithm such as a natural language processing (NPL) rule-based algorithm or neural network (NN)-based algorithm, to understand the content and context of the interaction data.

In some embodiments, a plurality of message data is created during a single interaction session with the lead in a conversation-like manner. The plurality of message data may each be targeted messages to the lead's immediate response (or interaction data) during the interaction session, for example, in a real-time communication over chat, a phone call, a video call, text prompts, and the like. As an example, during a chat communication with the lead, a first targeted message is created to initiate the conversation followed by a waiting period. Upon receiving a response from the lead, a second targeted message is created in response to the immediately received response from the lead followed by another waiting period. Such a process of generating and projecting targeted messages, each followed by a waiting period until a response is received, may be repeated until the interaction session is terminated. It should be noted that the interaction session including the plurality of message data mimics conversations between people, but with improved consistency and accuracy to project targeted messages that are tailored to the lead and/or the user's preference (e.g., company data, sentiment, vocabulary, etc.). To this end, in such embodiments, any of S230 through S250 may be performed iteratively over multiple iterations, where the message data is created at any or all of the iterations.

At S260, a trained classifier is applied to the textual data of the lead response to determine labels for the interaction data. In an embodiment, historical data on previous interactions with the lead, lead data such as, without limitation, personal and professional information may also be used for classifying the textual data of the lead response. The labels may indicate the outcomes of the interaction based on the lead response. It should be noted that the label provides a simple description of the interaction that is easily applicable and relevant to the engagement. In an embodiment, at least one algorithm may be applied to each of the other data and/or metadata of the interaction such as, but not limited to previous interactions (e.g., exchanged emails), number of participants in the interaction, time period between interactions with the lead, and the like, in order to identify a label for the interaction data. The algorithm is a neural network or any gradient descent-like algorithm.

In an embodiment, the labels for multi-label classification may be predefined and include, for example, but not limited to, “no answer”, “follow-up”, “wrong person”, “voicemail”, “bad timing”, “meeting booked”, and the like. The next step in the engagement pipeline and priority of the leads are determined based on the label determined of the interaction data. As an example, an interaction labeled as “follow-up” may be given priority over other labels such as “no answer” or “bad timing” and placed at the top of the queue. In the same example, the “follow-up” label may trigger the immediate creation of a new targeted message as described in S230. In an embodiment, the lead, interaction data, and the label may be stored in the database or memory as, for example, historical data.

In an embodiment, the classifier is trained using a supervised machine learning algorithm on training datasets to classify interaction data into predetermined labels. In a further embodiment, the classifier may be continuously trained through the usage of diverse datasets for enhanced accuracy. The classifier based on a pretrained neural network is trained using diverse datasets gathered from multiple internal and external sources to improve language understanding. In an embodiment, data within the training dataset may be manually labeled for a weak supervised learning. The accuracy of the classifier may be continuously improved with the reclassification of interaction data that are collected. In a further embodiment, the classifier may be configured to perform hierarchical classification of the interaction data based on the granularity of labels for which the classifier is trained.

It should be appreciated that the classification enables objective and consistent assessment of the interaction with the lead based on weights learned through training. In addition, the labels determined by the classifier provide clear insights into the interaction data to efficiently determine the next step of the process in the engagement pipeline. To this end, the next steps of the engagement pipeline may be consistently determined via the multi-stage pipeline without needing to reanalyze the interaction data, thereby increasing processing speed and efficiency. It should be noted that the determined labels provide additional insights for the user (e.g., sales team) that may otherwise not be discovered.

At S270, a next step for the lead is determined and performed. In an embodiment, the next step in the engagement pipeline is determined based on the labels determined by the trained classifier. The next step for the lead may include, for example, returning to the queue of rankings for the next round of interaction, applying at least one algorithm, closing engagement, or the like. The determined next step defines a succeeding operation to be suggested and/or performed in the engagement pipeline. The engagement pipeline outlines the steps and processes taken for engagement or sales processes. In an example embodiment, the lead may return to the queue of lead rankings upon determining the interaction as a “bad timing” label. In such a scenario, steps S210 to S240 may be performed using the most recent interaction as part of the previous interactions (historical data) for processing.

In an embodiment, the same next step may be performed for one or more labels. In a further embodiment, certain tags or weights may be added to an interaction data based on a classified label. As an example, assuming that all lead data and interaction data were the same, the interaction labeled “follow-up” will receive a time-tag of a predetermined time period and may be placed higher in the queue than the interaction labeled “no answer.”

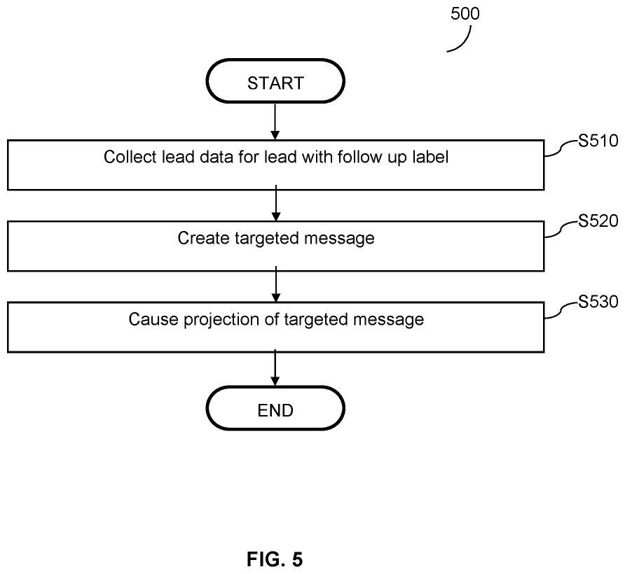

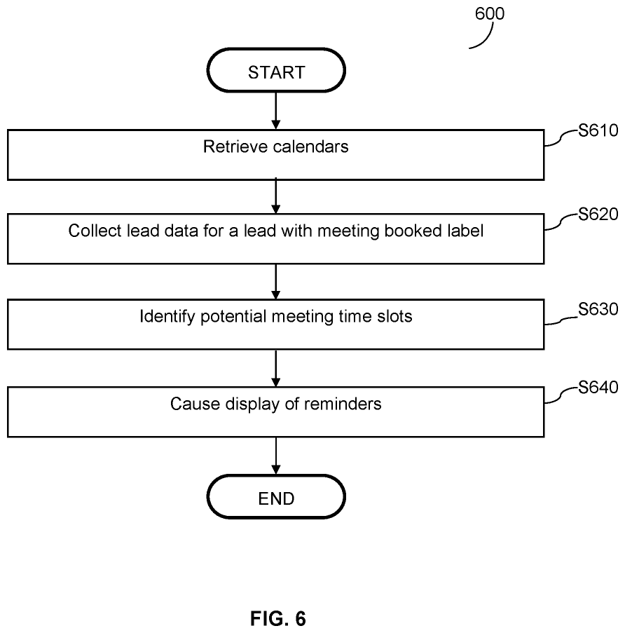

In an example embodiment, the next step for the lead may be to apply at least one algorithm to move on to the next stage in the engagement pipeline. Some example algorithms are introduced and discussed below in FIGS. 5 and 6. In an embodiment, the next step may be to close engagement with the lead at this stage of the engagement pipeline without moving further in the pipeline. In a non-limiting example, the engagement pipeline may be closed for the lead when the interaction is labeled as “don't call again”, “bad fit”, and the like. As noted above, the engagement pipeline may be a sales process from the first steps for sales (e.g., product research, etc.) to the closing of the deal whether through a successful deal closure or an early closure to stop pursuing the sales process.

FIG. 3 is an example flowchart 300 illustrating a method for aggregating potential leads according to an embodiment. The method described herein may be executed by a pipeline manager 130, FIG. 1. In an example embodiment, the method described herein may be executed at a ranker 131 in the pipeline manager 130, FIG. 1.

At S310, a plurality of potential leads is collected from various internal and external sources. The various external sources include, for example, but are not limited to, CRM systems, social media, online directories, company websites, and the like. The internal sources include, for example, but are not limited to, an internal CRM system, a customer directory, and the like, stored in a database (e.g., the database 140, FIG. 1). The plurality of potential leads includes leads (e.g., customers, etc.) that show interest in the company and/or product, that displayed a need for the product, and the like. In an example embodiment, the potential leads are selected from an online directory of an organization. In another example embodiment, the potential leads are collected from leads that are redirected to the company website from an online advertisement. The selected potential leads are in a subset.

At S320, lead data are extracted for each of the potential leads. The lead data includes relevant information of the leads including, for example, but not limited to, personal information, a professional background, industry, past interactions, and the like. In an embodiment, a natural language processing (NLP) technique may be employed to extract relevant lead data.

At S330, a score is determined for each of the potential leads by applying a trained model of the ranker. At least one algorithm, such as a machine learning algorithm is applied to the lead data collected and extracted for each of the potential leads in the plurality of potential leads. In an embodiment, the potential leads are ranked based on the generated score which defines the probability of completing the engagement, for example, the sales process. In a further embodiment, the rankings of potential leads are utilized for streamlining engagement as described above in FIG. 2. Portions of the potential leads may be filtered out, for example, based on a score lower than a threshold value. It should be noted that the scores and rankings generated herein reduce the number of potential leads to be further processed to conserve computer memory and processing power. At least one machine learning algorithm, such as a decision tree, or a neural network is trained using a training dataset to optimize ranking based on the probability of completing the sales process. In an embodiment, the model of the ranker may be continuously or intermittently trained using new data collected from closed sales processes including successful and unsuccessful engagement closures.

FIG. 4 is an example flowchart 400 illustrating a method for creating targeted messages using a generator according to one embodiment. The method described herein may be executed by a generator 132 of a pipeline manager 130, FIG. 1. It should be noted that the method described herein is discussed for one of the potential leads and may be performed in series or parallel for one or more potential leads.

At S410, lead data is collected of one of the potential leads. The lead data include relevant information about the lead such as, but not limited to, personal information (e.g., demographics, geographical location, hobbies, more), professional information (e.g., current job, job title, industry, and more), and the like, and any combination thereof, and may be ingested from a memory or the database. In addition, historical data on previous interactions that are stored in an internal database (e.g., the database 140, FIG. 1) may be retrieved. The historical data includes communication data (e.g., call transcripts, electronic mails (emails), instant messages (e.g., messages from chat-based tools including Slack™, WhatsApp™, Microsoft Teams™, etc.), and the like, and any combination thereof), as well as sentiment data, topic data, label, metadata (e.g., participants, time stamp, etc.) and the like for each communication data. In an embodiment, the historical data may also include current interaction data from the lead's response when an interaction session is being performed.

In an embodiment, the collected input data may be represented as vector embeddings. In an example embodiment, the communication data may be messages exchanged between sales professionals and the lead. It should be noted that a vast amount of communication data may be ingested in a larger sale process, which in return presents challenges in processing efficiency. In an example embodiment, during initial engagement, the historical data may be null and not include communications data from previous interactions. In a further embodiment, the communications data may include predetermined textual data that are templates for interacting with a lead and stored in the database. In an example embodiment, the predetermined textual data may be an email template draft based on user preference and/or company sentiment and guidelines or a general introductory chat message.

The historical data further includes sentiment data holding sentiments of communications data. The sentiments may be positive, negative, or neutral. In a further embodiment, the historical data may include topics data holding topics derived for an interaction based on its communication data. A topic is the context of the subject matter in the text (i.e., call transcripts). Examples of topics include the subject matter of, for example, but not limited to, “small talk,” “pricing,” “next step,” “contract,” “sports,” and so on. For each interaction (or communication data), there may be one or more different topics.

At S420, relevant data are extracted from the lead data and the historical data. In an embodiment, the lead data and the historical data may be processed using a neural network, such as long short-term memory (LSTM) and transformers, to identify words and/or phrases that may be considered as being relevant. The neural network for processing may be pretrained on general data, company-specific data, or may be trained from scratch.

In some embodiments, a customized language model pretrained using specific data of, for example, and without limitation, company, entity, industry, topic, and the like, may be implemented to identify relevant data (or words). As an example, a customized language model pretrained using company-specific data may identify relevant words for the company that may not be applicable for other companies. A non-limiting example of such a customized language model is described in more detail in U.S. patent application Ser. No. 18/160,085 (hereinafter referred to as '085 application) to Aloni-Lavi et al., assigned to the common assignee, the contents of which are hereby incorporated by reference.

At S430, formatting processes are applied to the relevant lead data of lead-related information and historical data including, for example, communication data, sentiment data, topic data, and more, to create a set of unified data formats. Such formats improve the efficiency of the processing at the generator using at least one algorithm. In an embodiment, S430 includes splitting the communications data into fixed-size data chunks, splitting the sentiment data into fixed-size data chunks, and extracting lead data from the database into a predefined data format. Such fixed-size data chunks and the like formatted data may be utilized in the generator. It should be noted that the formatted data provides a relatively uniform data structure for effective processing.

In an embodiment, S430 may include filtering out data chunks that cannot add meaningful information to the generation of a targeted message. For example, such data chunks that may be filtered out may be portions of the exchanged emails that are neither related to a deal being offered nor related to a meeting schedule. Any data chunks related to exchanged messages characterized as “small talk” may also be excluded. In another example, lead data unrelated to the deal and/or product of interest may be excluded.

At S440, a prompt for the generator is created based on the formatted input data. A prompt typically includes a command, background details, and a text that the command operates on. The background details may be based on formatted input data related to the lead data, historical data, metadata, current interaction data, and the like, and any combination thereof. For example, a prompt command may include “Rephase”, “Format”, “Reword”, and the like. A prompt may include more than one command. The background details may be based on formatted input data related to the lead data, the historical data (e.g., communications data, sentiment data, etc.), and the current interaction data. The text that the command operates on includes a data chunk from the communications data. A prompt may be generated for each data chunk created from the communications data. It should be noted that the prompt includes formatted input data that not only accurately represent the lead and the interaction with the lead, but also is focused on the relevant information. It should be further noted that such an accurate and concise prompt that is created by the pipeline manager enables faster processing, thereby conserving computer resources.

At S450, the created prompt is fed to the generator to generate message data. In an embodiment, one or more outputs from fed prompts are utilized to generate the message data. As noted above, the prompt includes formatted input data of at least one of lead data, historical data, current interaction data, and the like. In an embodiment, the message data may be textual data such as, for example, but not limited to, email messages, short message systems (SMS), and the like. In an embodiment, the generator is trained to output message data that are optimized to target the specific lead in order to increase the probability of success in engagement and sales. At least one algorithm, such as an advanced language model trained from scratch on historical data or pretrained using general text inputs using natural language processing, intelligent embedding-based retrieval (EBR) algorithms, and the like, is applied to generate the message data that is personalized and engaging to the lead.

In addition to creating personalized message data for the lead based on lead-related input data, in an embodiment, the generator may be further customized and fine-tuned for a specific, for example, company, entity, industry, and the like, by incorporating customized language models as discussed in S420. In a further embodiment, predefined rules may be provided to the generator to generate messages that are aligned with the organization's strategy. In an example embodiment, the predefined rules define messaging and branding guidelines, individual user preferences, and the like. As an example, the predefined rules may define the structure, length, sentiment, and the like, of the generated text.

In some embodiments, a generator (e.g., the generator 132, FIG. 1) that creates targeted messages includes a text-to-speech (TTS) model, automatic speech recognition (ASR) model, both, and the like that enables communication with a lead (or a customer) using audio and/or video data, for example, over a call. The targeted data are generated as described in FIG. 4, where lead data, historical data, and the like are used as input data to generate personalized targeted messages for the lead. In an embodiment, the generator 132 may be or may include an end-to-end (E2E) generator that may be configured to operate the ASR, NLP, and TTS models continuously to enable automated real-time conversations with a customer over a call. In an embodiment, one or more new targeted messages are rapidly generated based on initial input data (e.g., lead data, historical data, etc.) as well as ASR output data from the response for undisrupted interaction with the lead. The TTS model is used to generate audio data from the generated new targeted message to be projected to a lead over the call.

The models of the generator may be pretrained for a specific application (e.g., company, topic, etc.), by fine-tuning each model separately, by an end-to-end training process, or the like. In an embodiment, an ASR model may utilize a customized language model that identifies, for example, company-specific words that are notable during the interaction with the lead. An example of a customized language model is discussed in application '085 noted above. In an example embodiment, the ASR may utilize one or more customized language models based on a response from the lead during a single interactive session.

Models of the generator may be adjusted in real-time to appropriately and effectively communicate with the lead based on the response received. In an example embodiment, the conversation style and content of the generated text and/or output audio data may be changed. As an example, the interactive session may start using a customized language model for the company on the topic of “general introduction.” During the course of the interaction, when the lead shows interest in a specific product, the model may be adjusted to a customized language model trained for the specific product. In another example, the lead may show skepticism about a product, which in this case, the generator may be adjusted (or another customized language model is used) to communicate using a persuasive tone rather than informational. Selecting the customized language model based on interest (e.g., as represented in audio and/or text inputs provided by the user) allows for adjusting language processing during the interactive session in order to improve model performance as compared to using a single model for all language processing during interactions, particularly when multiple models are available for different aspects of conversation such as, but not limited to, different topics.

It should be noted that the adaptation of the model ensures that the interaction remains engaging and relevant. It should be further noted that data processing at the pipeline manager, particularly the generator, to process audio data to text, analyze text content, apply the text generator, and output audio data using the TTS model is performed at sufficiently rapid rates for continuous interactions. The generator allows objective decision-making based on trained machine learning algorithms to accurately and consistently determine targeted message data for projecting to a lead via a lead device.

FIG. 5 is an example flowchart 500 illustrating a method for performing a follow-up step according to an example embodiment. The disclosed method is an example of the next step that may be performed following the process described in FIG. 2 to perform the next step (S260). It should be noted that the process described herein is an example for illustrative purposes and does not limit the scope of the various disclosed embodiments described herein. The method described herein may be executed by a pipeline manager 130, FIG. 1.

At S510, lead data is collected for a lead with a “follow-up” label. The lead data includes relevant information of the lead and engagement, for example, but not limited to, personal information (e.g., geographical location, interests, demographics, etc.), professional information (e.g., a professional background, industry, etc.), past interactions, and the like. The lead data may be collected after a predetermined time from the most recent interaction and/or from entering the database (e.g., the database 140, FIG. 1). In an example embodiment, the predetermined time may be defined by a time-tag in the lead data added after the most recent interaction. In another embodiment, the lead may be placed within the ranking of the potential leads as described in FIG. 3. In an example embodiment, the “follow-up” label as part of the past interactions may increase the score, defining the probability of completing the sales process, for the respective lead. To this end, the respective lead can be placed higher in the ranking of potential leads in the engagement pipeline and/or the multi-stage pipeline.

At S520, a targeted message is created using the trained generator. The trained generator creates, based on the lead data, personalized textual data for the specific lead. The information included in the recent interaction data such as textual data of call transcripts, messages, method of interaction, metadata (e.g., participants, time stamp, etc.), and more, is used to generate the targeted message data. It should be noted that such customized message data is not only relevant, but the content will be coherent to interactions with the lead throughout the engagement pipeline. It should be further noted that the personalized message data created by the trained model are consistent with the lead data (also user preferences if input) and do not fluctuate based on interference of subjective input from other users, which may occur when a user handles such a process.

At S530, the targeted message is caused to be projected. The targeted message including personalized message data is provided to a lead via the lead device (e.g., the lead device 125, FIG. 1) in a text format (e.g., email message, short message, etc.). In some embodiments, the created message data may be output as an audio format through, for example, a speaker on the lead device, by applying a TTS model. In yet another embodiment, the personalized targeted message data may be projected to a lead as, for example, a multimedia including images, video, text, animations, and the like, and more. In an embodiment, the timing and frequency of output may be optimized based on collecting lead data through the engagement pipeline. It should be appreciated that the follow-up step helps ensure that potential leads (or customers) remain engaged and informed through the process while minimizing the risk of losing or overwhelming communications through the engagement pipeline.

FIG. 6 is an example flowchart 600 illustrating a method for scheduling a meeting according to an example embodiment. The disclosed method is an example of the next step that may be performed following FIG. 2 in S260. It should be noted that the process described herein is an example for illustrative purposes and does not limit the scope of the various disclosed embodiments described herein. The method described herein may be executed by a pipeline manager 130, FIG. 1, particularly the scheduler (SC) 134, FIG. 1.

At S610, calendars are retrieved and integrated. The calendars for the respective lead and a user (e.g., a sales representative) are collected and integrated.

At S620, lead data is collected for a lead. The lead data is collected for the lead with a “meeting booked” label. The lead data includes relevant information of the lead and engagement, for example, but not limited to, personal information (e.g., geographical location, interests, demographics, etc.), professional information (e.g., a professional background, industry, etc.), past interactions, associated metadata, and the like.

At S630, potential meeting time slots are identified. At least one algorithm is applied to the retrieved calendars and lead data to identify potential meeting times. In an example embodiment, preferences such as, but not limited to, working hours, time zones, and the like, which may be part of the retrieved calendars, may be utilized in identifying the potential meeting times. In a further embodiment, lead preferences may be utilized in the identification of time slots which may be obtained as part of the retrieved calendar and/or collected lead data. In an embodiment, the algorithm may be based on a set of heuristics to compare available time slots and smart decision trees to rank the best time slots according to the success rate of similar engagements (or sales deals) in the past.

At S640, reminders are caused to be displayed. The reminders may be displayed on a user device (e.g., the user device 120, FIG. 1) and a lead device (e.g., the lead device 125, FIG. 1) that is connected over a network. The reminder may be displayed as, for example, but not limited to, a notification, an alert, a portion of the calendar, an email message, and the like. In one embodiment, the generator (e.g., the generator 132, FIG. 1) may be utilized to generate the reminders that are customized for the lead by incorporating appropriate input data. In an embodiment, feedback (e.g., acceptance, rejection, rescheduling request, no feedback, etc.) may be received from the displayed reminder via the user device and/or the lead device. In an example embodiment, steps S630 and S640 may be iteratively performed until acceptance feedback is received. In another example embodiment, the steps S630 and S640 may be performed a predetermined number of times. In an embodiment, the frequency of causing a display of the reminder may be predefined. In another embodiment, such frequency may be determined based on lead data or lead calendar. It should be noted that scheduling as described herein allows objective selection and scheduling of meetings that incorporate user and lead's current and past engagements.

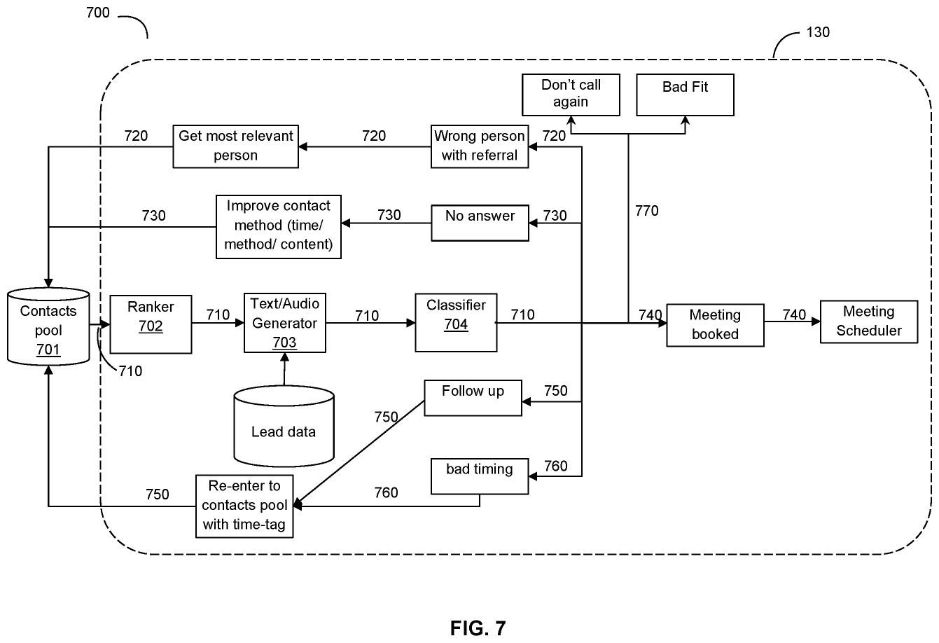

FIG. 7 is an example flow diagram 700 of an engagement pipeline according to example embodiments. The example flow diagram 700 illustrates the various possible operations that may be performed during engagement with a potential lead through the engagement pipeline and the multi-stage pipeline that is employed for streamlining the engagement. The operations are performed by the pipeline manager 130 (e.g., the pipeline manager 130, FIG. 1). It should be noted that the flow diagram 700 is presented as an example for illustrative purposes and does not limit the scope of the various disclosed embodiments described herein.

A multi-stage pipeline 710 includes operation through the multiple stages multi-stage pipeline of the engagement pipeline. One or more flows of the multi-stage pipeline 710 may be performed in the engagement pipeline that outlines the process of engagement with the lead. The pipeline manager 130 receives input data from a contacts pool 701 (e.g., databases). The input data from the contacts pool 701 includes, for example, but is not limited to potential leads, lead data (e.g., personal data, professional data, previous interaction data), metadata, and the like, and any combination thereof. The input data from the contacts pool 701 is ingested into a ranker 702 that is configured to determine scores for each of the potential leads. The ranker 702 is further configured to determine rankings (e.g., list) of the potential leads based on the determined scores.

The ranking of potential leads is provided to a text and/or audio generator 703. The text and/or audio generator 703 is further configured to select potential leads from the ranking and retrieve lead data for each of the selected leads. Targeted messages may be created based on lead data and/or generated prompts. In some embodiments, customized language models may be utilized to create targeted messages that are customized for the lead and, for example, the company. The created targeted messages are caused to be projected via a lead device for an interaction session. A response such as text data, audio data, no response, and the like, are analyzed. As an example, the response may be, without limitation, an email message, a voicemail, a telephonic message, no response, and the like, and more. In an embodiment, the text and/or audio generator 703 may generate a plurality of targeted messages during a single interaction session for conversation-like interaction with the lead in, for example, a chat, telephone call, video call, and the like.

A classifier 704 is configured to classify the received response as part of the interaction data into at least one of the multiple labels. The classifier 704 is further configured to identify the labels based on the interaction data and the lead data. In addition, the labels may be identified based on previous interaction data and metadata such as, but not limited to, participants, timestamp, duration between interactions, and the like. The next step of the engagement pipeline is determined based on the label and thus, operations associated with each label are shown in processes 720 through 770. One or more next steps of the engagement pipeline involve additional processing through the multi-stage pipeline. The interaction data and the respective labels may be stored at a database (e.g., the database 140, FIG. 1).

In the example embodiment, process 720 may be performed for interactions labeled as “wrong person with referral.” Data for the most relevant person may be retrieved and together, transmitted to the contacts pool 701 for processing through the multi-stage pipeline 710.

In another example embodiment, process 730 may be performed for interactions labeled “no answer” when no responses are received for the output targeted messages. The projection of the targeted message may be improved through feedback on, for example, the method of projection, timing, content, and the like. The additional data is transmitted to the contacts pool 701 together with the lead data for a new engagement determined through operations of the multi-stage pipeline 710.

In yet another example embodiment, process 740 may be performed for interactions labeled “meeting booked” when an agreement to schedule a meeting is detected in the interaction data. A scheduler (e.g., the scheduler 134, FIG. 1) including at least one algorithm for scheduling a meeting may be utilized to schedule a meeting at a determined optimal time slot with the lead and a user (e.g., sales personnel).

In yet another example embodiment, process 750 may be performed for interactions labeled “follow up” when the interaction occurred and, for example, a positive outlook is predicted from the response. A predetermined time-tag may be added to the interaction data, which together with the lead data is transmitted to the contacts pool 701. The lead and associated data are processed through multi-stage pipeline 710 for a new engagement.

In yet another example embodiment, process 760 may be performed for interactions labeled “bad timing” when an interaction occurs at a non-ideal time. In such cases, a predetermined time-tag may be added to the interaction data. The interaction data added to the lead data is transmitted to the contacts pool 701 according to process 750.

In yet another example embodiment, process 770 may be performed for interactions labeled “don't call again” or “bad”. As an example, such labels may be determined when the interaction was negative and no potential for successfully closing the deal (e.g., sales) was detected. The interaction data and the respective labels are stored in a memory and/or database.

It should be noted that the descriptions with respect to each label are disclosed for illustrative purposes and do not limit the scope of the various disclosed embodiments described herein. The labels may differ based on the training dataset used to train the classifier.

FIG. 8 is an example schematic diagram of a pipeline manager 130 according to an embodiment. The pipeline manager 130 includes a processing circuitry 810 coupled to a memory 820, a storage 830, and a network interface 840. In an embodiment, the components of the pipeline manager 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose central processing units (CPUs), microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 840 allows the pipeline manager 130 to communicate with other elements over the network 110 for the purpose of, for example, receiving data, sending data, and the like.

It should be understood that the embodiments described herein are not limited to the specific architecture illustrated in FIG. 8, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), general purpose compute acceleration device such as graphics processing units (“GPU”), a memory, and input/output interfaces. The computer platform may also include an operating system and microinstruction code. The various processes and functions described herein may be either part of the microinstruction code or part of the application program, or any combination thereof, which may be executed by a CPU or a GPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for streamlining language data processing through a multi-stage pipeline, comprising:
creating, based on input data, a targeted message for a lead using a trained generator, wherein the input data includes lead data;
causing projection of the targeted message via a user device of the lead;
determining at least a label for interaction data by applying a classifier, wherein the interaction data is collected from causing the projection of the targeted message to the lead, wherein the interaction data are processed for classification;
determining a next step based on the determined at least a label, wherein the next step is determined with respect to the lead; and
performing the next step upon determination.

2. The method of claim 1, further comprising:
receiving a list of a plurality of potential leads, wherein the list of the plurality of potential leads includes a subset of potential leads that are ranked based on scores, wherein each potential lead in the list of the plurality of potential leads has a score above a predetermined threshold value; and
selecting lead from the list of the plurality of potential leads.

3. The method of claim 1, further comprising:
iteratively repeating creating, causing projection, and processing the collected interaction data in near real-time.

4. The method of claim 1, wherein the trained generator is a customized language model that is trained for at least one of: a company, an entity, an industry, and a topic.

5. The method of claim 4, wherein the topic is a context of a subject matter in the language data, wherein the language data includes at least one topic.

6. The method of claim 1, wherein the creating the targeted message further comprises:
extracting relevant data using a trained language model from the input data, wherein the input data is expressed as vector embeddings;
formatting the extracted relevant data to create a unified data format, wherein formatting includes splitting data into fixed-size data chunks;
creating a prompt for the trained generator, wherein the prompt includes a command, background details, and textual data of the formatted relevant data; and
feeding the prompt into the trained generator.

7. The method of claim 1, wherein the targeted message is caused to be projected as at least one of: a text, an audio, a video, an image, a multimedia, and a virtual form.

8. The method of claim 1, further comprising:
collecting feedback data from at least one stage of the multi-stage pipeline; and
applying the feedback data to the trained generator to update the trained generator.

9. The method of claim 1, wherein the classifier is a multi-label classifier that applies at least one of: a neural network, a gradient-based algorithm, and a supervised machine learning algorithm.

10. The method of claim 1, wherein the next step includes scheduling a meeting with the lead, wherein scheduling further comprises:
retrieving a lead calendar and a user calendar;
identifying a potential meeting time slot by applying an algorithm to the retrieved lead calendar, retrieved user calendar, and the lead data; and
causing a display of a reminder, wherein the reminder is generated based on the identified potential meeting time slot.

11. The method of claim 10, wherein the display is presented as a part of a sales pipeline that indicates an engagement progress.

12. A non-transitory computer readable medium having stored thereon instructions for causing a processing circuitry to execute a process, the process comprising:
creating, based on input data, a targeted message for a lead using a trained generator, wherein the input data includes lead data;
causing projection of the targeted message via a user device of the lead;
determining at least a label for interaction data by applying a classifier, wherein the interaction data is collected from causing the projection of the targeted message to the lead, wherein the interaction data are processed for classification;
determining a next step based on the determined at least a label, wherein the next step is determined with respect to the lead; and
performing the next step upon determination.

13. A system for streamlining language data processing through a multi-stage pipeline, comprising:
a processing circuitry; and
a memory, the memory containing instructions that, when executed by the processing circuitry, configure the system to:
create, based on input data, a targeted message for a lead using a trained generator, wherein the input data includes lead data;
cause projection of the targeted message via a user device of the lead;
determine at least a label for interaction data by applying a classifier, wherein the interaction data is collected from causing the projection of the targeted message to the lead, wherein the interaction data are processed for classification;
determine a next step based on the determined at least a label, wherein the next step is determined with respect to the lead; and
perform the next step upon determination.

14. The system of claim 13, wherein the system is further configured to:
receive a list of a plurality of potential leads, wherein the list of the plurality of potential leads includes a subset of potential leads that are ranked based on scores, wherein each potential lead in the list of the plurality of potential leads has a score above a predetermined threshold value; and
select lead from the list of the plurality of potential leads.

15. The system of claim 13, wherein the system is further configured to:
iteratively repeat creating, causing projection, and processing the collected interaction data in near real-time.

16. The system of claim 13, wherein the trained generator is a customized language model that is trained for at least one of: a company, an entity, an industry, and a topic.

17. The system of claim 16, wherein the topic is a context of a subject matter in the language data, wherein the language data includes at least one topic.

18. The system of claim 13, wherein the system is further configured to:
extract relevant data using a trained language model from the input data, wherein the input data is expressed as vector embeddings;
format the extracted relevant data to create a unified data format, wherein formatting includes splitting data into fixed-size data chunks;
create a prompt for the trained generator, wherein the prompt includes a command, background details, and textual data of the formatted relevant data; and
feed the prompt into the trained generator.

19. The system of claim 13, wherein the targeted message is caused to be projected as at least one of: a text, an audio, a video, an image, a multimedia, and a virtual form.

20. The system of claim 13, wherein the system is further configured to:
collect feedback data from at least one stage of the multi-stage pipeline; and
apply the feedback data to the trained generator to update the trained generator.

21. The system of claim 13, wherein the classifier is a multi-label classifier that applies at least one of: a neural network, a gradient-based algorithm, and a supervised machine learning algorithm.

22. The system of claim 13, wherein the next step includes scheduling a meeting with the lead, wherein the system is further configured to:
retrieve a lead calendar and a user calendar;
identify a potential meeting time slot by applying an algorithm to the retrieved lead calendar, retrieved user calendar, and the lead data; and
cause a display of a reminder, wherein the reminder is generated based on the identified potential meeting time slot.

23. The system of claim 22, wherein the display is presented as a part of a sales pipeline that indicates an engagement progress.
